(19) United States
(12) Patent Application Publication
(10) Pub. No.: US 2023/0005050 A1
(43) Pub. Date: Jan. 5, 2023

(54) CREATION TRADING SYSTEM

(71) Applicant: Hyunsuck OH, Seoul (KR)

(72) Inventor: Hyunsuck OH, Seoul (KR)

(21) Appl. No.: 17/931,793

(22) Filed: Sep. 13, 2022

Related U.S. Application Data
(63) Continuation of application No. PCT/KR2021/019923, filed on Dec. 27, 2021.

(30) Foreign Application Priority Data
Mar. 11, 2021 (KR) 10-2021-0031828

(51) Int. Cl. G06Q 30/06; G06Q 30/02; G06Q 30/08; G06F 21/10

(52) U.S. Cl. CPC G06Q 30/0641; G06Q 30/0206; G06Q 30/08; G06F 21/10

(57) ABSTRACT

Disclosed herein is a creation trading system. The creation trading system includes: a creation posting unit connected to a user account and registering creation details; a price determination mode setting unit determining a selling intention and determining whether to select an auction or a fixed price system; and a server interconnecting the plurality of user accounts.

### CROSS-REFERENCE TO RELATED APPLICATION

This application is a continuation of International Patent Application No. PCT/KR2021/019923, filed on Dec. 27, 2021, which claims priority to and the benefit of Korean Patent Application No. 10-2021-0031828, filed on Mar. 11, 2021, the disclosure of which is incorporated herein by reference in its entirety.

### TECHNICAL FIELD

The present invention relates to a creation trading platform capable of efficiently publishing and trading creations through a user terminal.

### BACKGROUND ART

Recently, with rapid development of computer internet technology, electronic commerce using the Internet to trade goods, services, etc. is also explosively increased.

The electronic commerce is a method of selling goods through internet e-commerce websites.

The electronic commerce can simplify a distribution structure compared to conventional offline-type merchandise trade, reduce labor costs, and can supply goods to purchasers at low prices due to a low risk in product inventory management.

Purchasers can easily order goods by connecting to an e-commerce website through the internet without directly visiting an offline store, thereby conveniently purchasing the goods at low prices.

On the other hand, creations mean all products by mental efforts of persons. The civilization of technology developed dramatically gradually improves people's quality of living and enriches the life. So, people actively carry out intellectual creative activities to satisfy the people's mental desires in various cultural and art fields.

Intellectual creations in modern society do not only satisfy human's mental desires but also provide considerable economic values in conjunction with commercialism aiming at pursuit of profit. Therefore, intellectual property industry to develop, commercialize, and sell various artistic and cultural contents is emerging as a new industry field.

However, creations made by various creative activities area difficult to be known to a plurality of unspecified individuals as long as they are not creations made by well-known persons, and most of the creations are buried without being eligible for evaluation despite the artistic values.

Moreover, even if a creation is a creative work of a celebrity, it requires excessive efforts and costs when being promoted, sold, and exhibited, and a commercial distribution process of the personal creation is very difficult.

On the other hand, with the rapid supply of high-speed internet network and rapid progress of communication media, various web contents capable of promoting and publishing personal creations to many and unspecified persons through internet regardless of time, space, or specific requirements have been widely used.

However, such web contents are just promoted or published partially and individually through a homepage directly opened by a creator or internet portal sites, blogs, or internet community sites classified by fields, and cannot provide systematic services for the main purpose of transaction of creations.

Therefore, the inventors of the present invention have completed the present invention by finding implementation of a new platform capable of allowing very unspecified persons to easily access, appreciate and trade personal creations through the internet and terminal devices widely utilized in life.

### DISCLOSURE

### Technical Problem

Accordingly, the present invention has been made in view of the above-mentioned problems occurring in the related art, and it is an object of the present invention to provide a platform capable of allowing individuals to actively trade creations.

### Technical Solution

To accomplish the above-mentioned objects, according to the present invention, there is provided a creation trading system including: a creation posting unit connected to a user account and registering creation details; a price determination mode setting unit determining a selling intention and determining whether to select an auction or a fixed price system; and a server interconnecting the plurality of user accounts.

In an embodiment, the creation is one or more selected from groups consisting of a literary work, a music work, a play work, an art work, a photo work, a video work, and a figure work.

In an embodiment, the creation is divided into a tangible thing and an intangible thing. In a case in which the creation is a tangible thing, an image file of the tangible thing is registered on the creation posting unit. In a case in which the creation is an intangible thing, a portion or the entire of the intangible thing is registered in the creation posting unit.

In an embodiment, in the case in which the creation is an intangible thing, a user registers selling conditions of the creation together with whether to transfer the copyright and set the selling price varied according to whether to transfer the copyright.

In an embodiment, in the case in which the creation is an intangible thing, the user sets a reading fee according to the disclosing degree of the creation or sets to expose an advertisement according to reading.

In an embodiment, the user sets an index and a category related to the creation on the creation posting unit, and sets to expose associated creations according to the user's search.

In an embodiment, the creation trading system further includes a similarity determination unit for analyzing similarity between the creation registered in the creation posting unit 111 and an already known creation.

In an embodiment, the creation trading system further includes a sale request unit for delivering a purchase intention or an estimated purchase amount for the creation in a case in which the selling intention is not set in the price determination mode setting unit.

### Advantageous Effects

The creation trading system according to the present invention allows people to approach various creations unknown to the public.

Moreover, the creation trading system according to the present invention enables people to smoothly and conveniently trade creations.

It is to be understood that the effects of the present invention are not limited to the above-described effects and include all of the effects derivable from the detailed description or claims.

### DESCRIPTION OF DRAWINGS

FIG. 1 is a view simply illustrating a creation trading system according to a first embodiment of the present invention.

FIG. 2 is a schematic diagram of the creation trading system according to the first embodiment of the present invention.

FIG. 3 is a diagram illustrating a user interface (I/F) of the creation trading system according to the first embodiment of the present invention.

FIG. 4 is a schematic diagram of a creation trading system according to a second embodiment of the present invention.

FIG. 5 is a diagram illustrating a user interface (I/F) of the creation trading system according to the first embodiment of the present invention.

### MODE FOR INVENTION

The terms including descriptive or technical terms which are used herein should be construed as having meanings that are obvious to one of ordinary skill in the art. However, the terms may have different meanings according to an intention of one of ordinary skill in the art, precedent cases, or the appearance of new technologies.

Moreover, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Unless otherwise defined, all terms (including technical and scientific terms) used herein have the same meaning as commonly understood by one of ordinary skill in the art to which this inventive concept belongs.

It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

The numerical range includes the numerical values defined in the range. All maximum numerical limits given throughout this specification include all lower numerical limits as if the lower numerical limits were clearly written.

All minimum numerical limits given throughout this specification include all higher numerical limitations as if the higher numerical limit were clearly written. All numerical limits given throughout this specification will include all better numerical ranges within the broader numerical ranges, as if narrower numerical limits are clearly written.

In the following description, terms such as “unit”, “means”, “part”, and the like may indicate a unit for covering at least one function or operation, and for example, may be a hardware component, such as a processor or a circuit, and/or a software component executed by hardware, such as a processor.

Hereinafter, with reference to the attached drawings, preferred embodiments of the present invention will be described in detail, but it should be understood that there is no intent to limit the present invention to the particular forms of the embodiments.

In an aspect of the present invention, a creation trading system implemented through the internet includes: a creation posting unit 111 connected to a user account and registering creation details; a price determination mode setting unit 112 determining a selling intention and determining whether to select an auction or a fixed price system; and a server 120 interconnecting the plurality of user accounts.

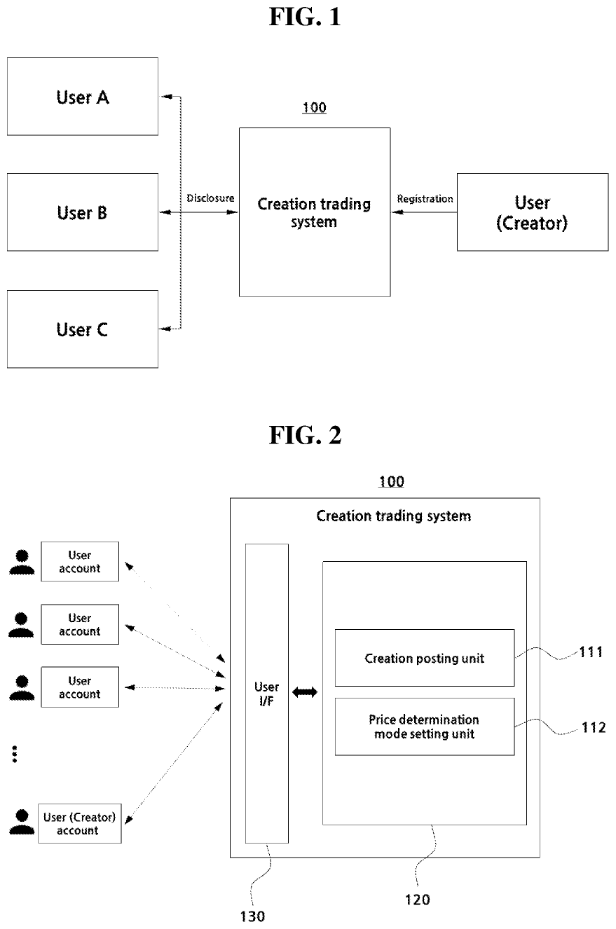

With reference to FIG. 1, some of users can register creations to the system, and a number of unspecified users can freely access opened creations through the system.

The creation trading system 100 freely opens an individual's creation, provides a space in which various people can access, and enables users to trade individual creations through the internet without a space for exhibition.

The system may associate a payment of an amount of compensation according to a predetermined activity to provide an environment and motive in which an individual's creation can be actively published.

Users can see various creations through the creation trading system 100, and can feedback to each other.

The creations cover all kinds of creative products by people's mental efforts, and are not limited in their kinds. The creations include patent rights, utility model rights, and design rights as well as works, and include all kinds of creative works, such as music, art, video, animation, webtoon, character, emoticon, font, computer game, mobile game, drama, movie, documentary, musical, opera, play, synopsis, script, and the like.

The works are creative works expressing human ideas or feelings and are protected by copyright, for instance, may be one or more selected from groups consisting of a literary work, a music work, a play work, an art work, a photo work, a video work, and a figure work, but are not limited thereto.

The literary work means a work expressed in speaking and writing, and may include a poem, novels, an essay, a script, a thesis, a lecture, and a sermon, but is not limited thereto.

The music work means a work expressed by music, and the music may be expressed with instruments or by a person. The music work includes all kinds of music works recorded or unrecorded on a score.

The play work means a work represented by movements, such as a play, a dance, a musical, and the like, and includes movements directly expressed by gestures and movements recorded in drawings or in a dance notation.

The art work means a work expressed by a line, a shape, and a color, includes paintings, a design, a calligraphy, a sculpture, crafts, and the like, but is not limited thereto.

The photographic work means a work creatively expressed by photography, and includes digital photo data as well as an analog picture.

The video work means a work represented by continuous moving images connected to each other, and includes moving images in a movie, an advertisement, a video game, and the like, regardless of existence of sound, but is not limited thereto.

The figure work means a work represented by a map, a diagram, a blueprint, a rough map, a model, and other figures.

In addition, the various types of creative works are a tangible thing and an intangible thing. The tangible thing and the intangible thing are different in a posting method or a trading method from each other due to their characteristics.

The tangible thing is a creation having a shape, and a direct delivery of the corresponding work may be demanded for transaction of the creation. For instance, the tangible thing may be a unique creation, for example, a picture or a sculpture, directly made by a creator.

On the other hand, the intangible thing is a creation not having a shape, is capable of being copied in various ways, such as writings (for example, a script or a novel), music, and the like in digital data, and the tangible thing and the intangible thing can be obviously distinguished according to general knowledge on the corresponding transaction.

Referring to FIG. 2, the creation trading system 100 includes: a creation posting unit 111 connected to a user account; a price determination mode setting unit 112; and a server 120 for interconnecting the users.

The creation posting unit 111 is connected to a user account, and registers details of the creation.

The creation posting unit 111 is a predetermined area embodied on a webpage allowing users to open information on creations and unspecified individuals to access, so as to induce individuals to post information on creations registered on the creation posting unit 111 and to access the information.

The user can create a user account in the creation trading system 100, and manage a page provided to the user through the user account.

The “account” is a unique system capable of verifying the identity of the user, and each subject identified through the account can connect to the system.

The user can register a creation through the webpage having the creation posting unit 111, access a webpage provided to another user, and use various functions for webpage management, for example, creation registration, creation deletion, reply management, subscription management, page monitoring, chat window management, message management, etc.

The price determination mode setting unit 112 is an area for determining matters related to sales of a creation to register the creation, and the user can determine a selling intention and determining whether to select an auction or a fixed price system through the price determination mode setting unit 112.

The user can register and open the creation. In this instance, the user can post information on the creation only for the purpose of disclosure without selling.

In a case that the user posts information on the creation only for the purpose of disclosure, since the user can open the creation without setting the selling intention, the user may not set the price determination method, such as an auction or a fixed price system, since the user did not set the selling intention.

In a case that the user posts information on the creation for the purpose of sales, the user can set the selling intention and open the creation. In this instance, the user can set various kinds of information related to the price determination.

Matters necessary for determining the price of the creation are, for example, the minimum price, selling price, auction or fixed price system, and a selling period, but are not limited thereto, and may include the details necessary for price determination.

That is, in a case of selling the creation at a fixed price, the user can set the selling price and the selling period. Alternatively, in a case of selling the creation through an auction, the user can set relevant matters, such as an auction method, the minimum price, an auction period, and so on.

The server 120 refers to a computer or software for providing services from a computer network to another computer, and interconnects the plurality of user accounts one another to operate the system according to the present invention.

The creation trading system 100 is implemented through user terminals and a communication network for interconnecting the user terminals one another, and a number of users can transmit and receive various data through their terminals.

The terminal refers to a device allowing the user to input data or output a processing result, and can be connected to a central server 120 through the communication network. The server 120, the network, the database, and the like for constructing the system according to the present invention are widely known in the art.

The terminal may be one among a smart phone, a portable terminal, a mobile terminal, a personal digital assistant (PDA), portable multimedia player (PMP), a telematics terminal, a navigation terminal, a personal computer (PC), a notebook computer, a slate PC, a tablet PC, an ultrabook, a wearable device 401, such as a smart watch, a smart glass terminal, a head mounted display (HMD), a Wibro terminal, an internet protocol television (IPTV) terminal, a smart TV, a digital broadcasting terminal, an audio video navigation (AVN) terminal, an audio/video (A/V) system, a flexible terminal, and so on, but there is no specific limitation if the user can input and output data.

The creation trading system 100 includes the user interface 130 for implementing the system and the server 120 for storing and processing the system-related program and data. The user terminals communicate one another via the server 120 of the system.

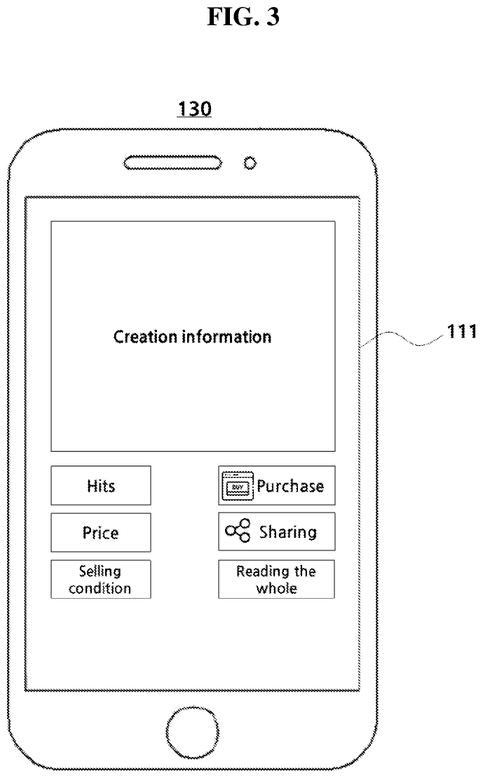

Referring to FIG. 3, the user interface 130 implements the creation trading system 100 to allow the users to use the system 100 through their terminals, and includes various menu screens having various data, such as text, image data (including various information data), icons, a list menu, a combo box, and the like.

The user interface 130 is implemented through a means capable of transferring information to the user, for example, a liquid crystal display (LCD), a thin film transistor liquid crystal display (TFT-LCD), an organic light-emitting diode (OLED), a flexible display, a 3D display, an e-ink display, and a light emitting diode (LED).

The communication network can transmit and receive data through various communication technologies through: a wireless internet technology, such as wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.6, long term evolution (LTE), long term evolution-advanced (LTE-A), wireless mobile broadband service (WMBS), and the like; short-range communication technology, such as Bluetooth, radio frequency identification (RFID), infrared data association (IrDA), ultra wideband (UWB), Zigbee, near field communication (NFC), ultrasound communication (USC), visible light communication (VLC), Wi-Fi, Wi-Fi direct, and the like; cable communication technology, such as power line communication (PLC), USB communication, Ethernet, serial communication, optical/coaxial cable, and the like; and other various communication technologies which are not listed above.

Referring to FIG. 3, the user interface 130 displays creation information, a purchase button, a sharing button, hits, a selling price, selling conditions, an entire viewing button, and the like, and the user can examine the creation through the user interface 130 and determine whether to trade the creation in consideration of the selling price.

The user interface 130 is implemented in a variety of forms, and is not limited specifically if the user interface 130 can achieve the objects of the present invention.

In particular, since forms of the webpage or the platform for transaction of goods are widely known, the creation trading system 100 can be updated continuously in consideration of the forms of the webpage or the platform.

In this case, the creation can be divided into a tangible thing and an intangible thing, and the creation registration method is varied according to whether the creation is a tangible thing or an intangible thing.

That is, in a case in which the creation is a tangible thing, an image file of the tangible thing can be registered on the creation posting unit 111.

The image file is to generate and store a digital image, and includes detailed information on the appearance of the creation, such as a photograph or an image.

On the other hand, in a case in which the creation is an intangible thing, the creation can be posted on the creation posting unit 111 through various means capable of expression the creation. User can register a portion or the entire of the intangible thing.

In the case in which the creation is an intangible thing, the user can register selling conditions of the creation together with whether to transfer the copyright and the selling price may be varied according to whether to transfer the copyright.

That is, in the case in which the creation is an intangible thing, it is possible to determine various matters related to transfer and usage of the creation, set a higher selling price if all rights of the creation including copyright are sold, and to set a lower selling price if only usage of the creation is permitted.

Specifically, in a case in which the intangible thing is music, and in a case in which all or a portion of reproduction right, performing right, public transmission rights (broadcasting right, transmission right, and digital audio transmission right), exhibition right, distribution right, lending right, and derivative work creation right of the corresponding music are permitted, it is possible to set a transaction price corresponding to the above. In a case in which all of the copyrights including the above-mentioned rights are transferred, it is possible to set a higher transaction price. The creation trading system 100 can implement the interface 130 related to various selling option settings of the creation.

In addition, in a case in which the creation is an intangible thing, the creation trading system 100 may set a reading fee according to the disclosing degree of the creation or expose an advertisement.

That is, in a case in which the creation is an intangible thing which does not require transfer and is free to reproduce, since many unspecified individuals can use or consume the corresponding creation without any charge of the copyright of the creation, the user can adjust the disclosure conditions for the corresponding creation.

The user can open only a portion of the corresponding creation. In a case in which a person wants to read the whole creation, the person can access the whole creation after paying the reading fee set by the user, so that the user can obtain earnings without selling of the creation.

In addition, the user can expose an advertisement together with disclosure of the corresponding creation.

The user determines whether to expose an advertisement according to reading of the creation through an advertisement system associated with the creation trading system 100, so that the user can obtain earnings according to advertisement's impressions without selling of the creation.

The creation trading system 100 includes a user interface 130 for setting the disclosure degree of the creation or advertisement exposure.

The creation trading system 100 sets an index and a category related to the creation on the creation posting unit 111, and exposes associated creations according to the user's search.

The “index” refers to a key set and an address for identifying, locating, searching or retrieving elements to easily find important words, items, names, and the likes. The user can set the relevant index to allow many unspecified individuals to easily access the creation.

In particular, since a creation may not externally expose a creator's intended concept by its nature, the user can set an index, thereby promoting the access to the corresponding creation.

The “category” has a generalized range in classifying the concept of the creation, such as language, country, type, and form of the creation. The user who uses the creation trading system 100 can conveniently access the creation having desired properties through the classification of the creation.

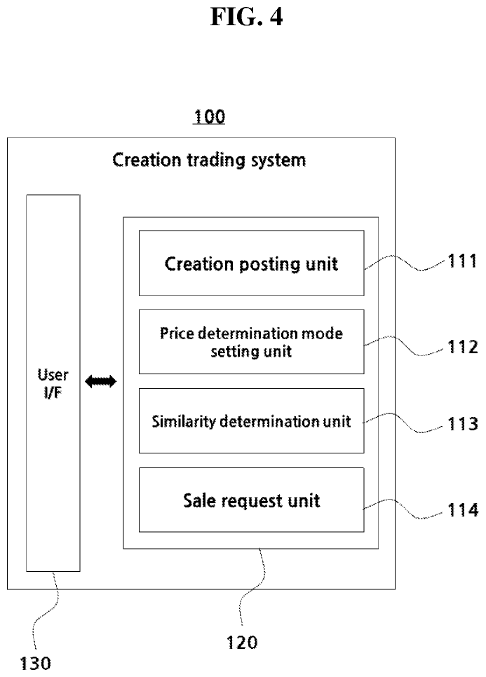

Referring to FIG. 4, the creation trading system 100 further includes a similarity determination unit 113 for analyzing similarity between the creation registered in the creation posting unit 111 and an already known creation.

The similarity determination unit 113 provides similarity-related information of the creation to the user so that the user can refer to the information at the time of transaction of the creation. The similarity can be calculated in various ways, such as scores or ratings, as needed.

The creation can be reproduced or copied in various forms, and there may occur a situation in which a creation made by copying a creation of another person is registered and sold.

Therefore, the creation trading system 100 analyzes similarity between the creation and the previously known creations in order to prevent reproduction or copy of creations of other persons, and provides information on whether the corresponding creative is copied or not.

The creation trading system 100 includes a software algorithm to determine similarity, and selects the most similar creation by comparing the creation registered by the user with the previously known creations through various methods.

The scope of the previously known creations is not limited. The creation trading system 100 searches creations with high similarity from the database or webpages of the whole world, and calculates a similarity value between the creations in a predetermined method.

The similarity determination unit 113 is to calculate data statistics. Software, algorithms, servers, networks, database structures and the like for constructing the system are widely known in the art.

Referring to FIG. 4, when the selling intention is not set in the price determination mode setting unit 112, the creation trading system 100 further includes a sale request unit 114 for delivering a purchase intention or an estimated purchase amount for the creation.

The user can disclose the creation only for the purpose of disclosure without selling. In this case, the user cannot proceed transaction of the creation since not setting the selling intention.

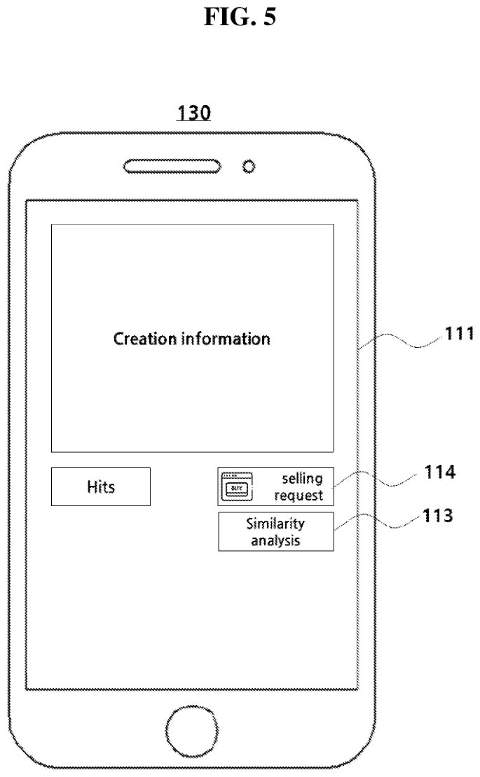

Therefore, in a case in which the selling intention of the creation only for the purpose of disclosure is not set, the sale request unit 114 can transfer other person's intention to buy the creation, and the user who registered the creation can determine whether to sell the creation through the request (FIG. 5).

In this instance, the user who registered the creation can establish a transaction in a manner of agreeing with the purchase intention, or promote the transaction of the creation by setting a selling intention of the creation in consideration of the request.

The sale request unit 114 allow many unspecified individuals to evaluate the value of the creation in a manner of transferring an estimated purchase amount regardless of the purchase intention, and the user who registered the creation can set a selling intention for the creation in consideration of the estimated purchase amount so as to promote the transaction of the creation.

Referring to FIG. 5, the similarity determination unit 113 and the sale request unit 114 may be implemented together on the interface 130 implementing the creation posting unit 111 in an easily operatable manner, but are not specifically limited thereto.

The present invention can be embodied as a computer-readable code on a medium in which a program is recorded.

A computer-readable medium includes all kinds of recording devices in which data readable by a computer system is stored. The computer-readable medium may be, for instance, a hard disk drive (HDD), a solid state disk (SSD), a read-only memory (ROM), a random access memory (RAM), a CD-ROM, a magnetic tape, a floppy disk, an optical data storage device, and the like.

The above description is only exemplary, and it will be understood by those skilled in the art that the invention may be embodied in other concrete forms without changing the technological scope and essential features. Therefore, the above-described embodiments should be considered only as examples in all aspects and not for purposes of limitation. For example, each component described as a single type may be realized in a distributed manner, and similarly, components that are described as being distributed may be realized in a coupled manner.

The scope of the present invention is defined by the appended claims, and encompasses all modifications or alterations derived from meanings, the scope and equivalents of the appended claims.

### EXPLANATION OF REFERENCE NUMERALS

100: Creation trading system

111: Creation posting unit

112: Price determination mode setting unit

113: Similarity determination unit

114: Sale request unit

120: Server

130: User interface

1. a creation trading system comprising:
a creation posting unit connected to a user account and registering creation details;
a price determination mode setting unit determining a selling intention and determining whether to select an auction or a fixed price system; and
a server interconnecting the plurality of user accounts.

2. The creation trading system according to claim 1, wherein the creation is one or more selected from groups consisting of a literary work, a music work, a play work, an art work, a photo work, a video work, and a figure work.

3. The creation trading system according to claim 1, wherein the creation is divided into a tangible thing and an intangible thing,
wherein in a case in which the creation is a tangible thing, an image file of the tangible thing is registered on the creation posting unit, and
wherein in a case in which the creation is an intangible thing, a portion or the entire of the intangible thing is registered in the creation posting unit.

4. The creation trading system according to claim 3, wherein in the case in which the creation is an intangible thing, a user registers selling conditions of the creation together with whether to transfer the copyright and set the selling price varied according to whether to transfer the copyright.

5. The creation trading system according to claim 3, wherein in the case in which the creation is an intangible thing, the user sets a reading fee according to the disclosing degree of the creation or sets to expose an advertisement according to reading.

6. The creation trading system according to claim 1, wherein the user sets an index and a category related to the creation on the creation posting unit, and sets to expose associated creations according to the user's search.

7. The creation trading system according to claim 1, further comprising:
a similarity determination unit for analyzing similarity between the creation registered in the creation posting unit 111 and an already known creation.

8. The creation trading system according to claim 1, further comprising:
a sale request unit for delivering a purchase intention or an estimated purchase amount for the creation in a case in which the selling intention is not set in the price determination mode setting unit.
